(19) United States
(12) Patent Application Publication
(10) Pub. No.: US 2002/0041343 A1
(43) Pub. Date: Apr. 11, 2002

(54) Display apparatus improved to reduce electrostatic charge on display screen and leakage of electromagnetic field outside display apparats

(76) Inventors: Kunio Ikui, Kanagawa (JP); Yoichi Matsubara, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/817,241

(22) Filed: Mar. 27, 2001

(30) Foreign Application Priority Data
Apr. 11, 2000 (JP) P2000-108978

(51) Int. Cl. H04N 5/65

(52) U.S. Cl. 348/819; 348/820

(57) ABSTRACT

A stacked film, which has a conductive film and a dielectric film formed on the conductive film, is stuck on a front surface of a panel portion of a cathode ray tube. One end of a conductive tape is stuck on the dielectric film of the stacked film, and the other end of the conductive tape is stuck on a band functioning as a ground portion of the cathode ray tube. The conductive tape has a conductive sticky layer which has a sheet resistivity in a range of 10 Ω/cm² to 1 KΩ/cm². The conductive film of the stacked film is electrically connected to the band of the cathode ray tube via the conductive tape. With this configuration, electrostatic charges on a display screen and leakage of an electromagnetic field from the display screen can be reduced. Further, since the sticky layer of the conductive tape has a specific electrical resistance, even if a high voltage is generated due to a discharge in the display apparatus, a discharge between the conductive film of the stacked film and the conductive tape can be suppressed and thereby the conductive film can be prevented from being broken.

### BACKGROUND OF THE INVENTION

The present invention relates to a display apparatus, and particularly to a display apparatus capable of preventing the occurrence of electrostatic charges and leakage of electromagnetic fields on a display screen of the display apparatus.

Display apparatuses used for computers are generally located close to, that is, apart short distance from operators using the computers. In recent years, electromagnetic fields, particularly at a VLF band (2 to 400 KHz) and an ELF band (5 to 2000 Hz), leaked from display apparatuses have come to grow a matter of concern for the health of human bodies. To limit such leakage of electromagnetic fields, standards such as MPR-11 and TCO have beeen established mainly in Europe, and it has been increasingly needed to develop display apparatuses adaptable to these standards.

The leakage of electromagnetic fields from a display apparatus can be reduced to some extent by canceling it via a circuit, or shielding it by means of a suitable shield plate.

To more effectively reduce the leakage of electromagnetic fields from a display apparatus, there has been disclosed a method of providing a transparent conductive film on a display screen of the display apparatus and connecting the conductive film to a ground portion of the display apparatus (Technical Report of Television Association, Vol. 1, No. 2, 1995. 1).

In this method, the transparent conductive film is made from an oxide such as ITO (Indium Tin Oxide) or SnO₂, or a metal such as Pd, Au, Cr, or Ti.

Such a transparent conductive film, however, has a problem. Since the refractive index of the above-described material of the conductive film is generally higher than and quite different from that of air, external light such as illumination light is significantly reflected from the display screen. As a result, characters and/or graphics displayed on the display screen are overlapped to reflection images of external light, so that the characters and/or graphics cannot be desirably displayed on the display screen.

To solve such a problem, there has been generally adopted a method of forming at least one anti-reflection layer on the above-described conductive film.

The formation of the anti-reflection film on the conductive film, however, has a problem. Since a dielectric substance such as SiO₂, Al₂O₃, ZrO₂, or TiO₂, used as the material of the anti-reflection film, hags a volume resistivity which is as high as 10¹⁰ Ωcm or more, the conductive film covered with the anti-reflection film is difficult to be electrically connected to a ground portion of a display apparatus.

In particular, for a display apparatus used for a computer, as described in Japanese Patent Laid-open Nos. Hei 3-266801 and Hei 1-204130, a coating film made from a fluorine compound is sometimes formed on a anti-reflection film for improving the durability of the anti-reflection film and preventing the occurrence of contamination caused by fingerprint or the like. In such a case, a conductive film covered with not only the anti-reflection film but also the coating film is further difficult to be electrically connected to a ground portion of the display apparatus.

To electrically connect a conductive film covered with a anti-reflection film to a ground portion of a display apparatus, there have been proposed, for example, the following methods (1) to (5):

(1) The first prior art method is intended to mechanically remove a portion, to be electrically connected to a ground portion, of a anti-reflection film. However, since the anti-reflection film is very thinly formed for ensuring the anti-reflection function thereof, it is difficult to mechanically peel a portion of the anti-reflection film. If such a portion of the anti-reflection film is forcibly peeled, there may occur an inconvenience that the entire films containing a conductive film under the anti-reflection film be peeled. Further, it may be conceived to remove a portion of the anti-reflection film by chemical etching or the like; however, in this case, a large scale etching system is required for carrying out the chemical etching.

(2) The second prior art method is intended to form a anti-reflection film in a state in which a portion, to be electrically connected to a ground portion, of a conductive film is masked. For example, Japanese Patent Laid-open No. Hei 2-94296 discloses a method of masking, before formation of a anti-reflection film, a portion, to be electrically connected to a ground portion, of a conductive film by using a movable plate or the like. However, in this case, a special jig for masking and a special apparatus for moving the movable plate are required to be provided for each of sizes of display apparatuses, and therefore, a large scale manufacturing system is required to be provided for forming the anti-reflection film. Actually, it is difficult to provide such a large scale manufacturing system for forming the anti-reflection film.

(3) The third prior art method is intended to electrically connect a conductive film covered with a anti-reflection film by using soldering, as disclosed for example in Japanese Patent Laid-open No. Hei 1-286229. However, if the conductive film is formed on a plastic base, the plastic base may be thermally deformed by soldering because a crystallization temperature of a plastic material is generally lower than a melting point of solder. Accordingly, in the case of adopting this soldering method, it takes a lot of labor to control the soldering condition and to perform 100% inspection for products.

(4) The fourth prior art method is intended to sequentially form a conductive film and a anti-reflection film on a plastic base, cut the films together with the plastic base into a size corresponding to that of a display screen of a display apparatus, and electrically connect the conductive film to a ground portion by making use of the cut surface of the conductive film. In this method, however, since the conductive film is very thin and thereby the cut area thereof is very narrow, it is difficult to obtain a positive connection between the conductive film and a ground portion, and further the conductive film may be broken and chipped at the cut surface and its neighborhood. Further, when the plastic base formed of a thin film is stuck on the display screen of the display apparatus by using a sticky agent or an adhesive, the sticky agent or adhesive may be protruded to cover the cut surface of the conductive film. In such a case, it is difficult to obtain the positive electrical connection between the conductive film and the ground portion.

(5) The fifth prior art method is intended to stick a conductive sticky tape on a conductive film formed on a display screen for preventing the occurrence of electrostatic charges on the display screen, and to ground the conductive film by using the conductive sticky film. In this method, however, if a conductive film having a sheet resistance of about 100 Ω/□ to 10 KΩ/□ is used for shielding unnecessary electromagnetic fields, sputtering is generated between the conductive film and the conductive sticky tape due to high electric charges induced on the front surface of the display apparatus, thereby to cause breakage of the conductive film.

### SUMMARY OF THE INVENTION

An object of the present invention is to provide a display apparatus capable of preventing the occurrence of electrostatic charges on a display screen and leakage of an electromagnetic field from the display screen, and also preventing the breakage of a conductive film provided on the display screen for reducing the leakage of an electromagnetic field.

To achieve the above object, according to an aspect of the present invention, there is provided a display apparatus having a display screen, including: a conductive film stuck on the display screen; a dielectric film formed on the surface of the conductive film; and a conductive tape including a conductive base and a conductive sticky layer; wherein the conductive sticky layer has a specific electrical resistance; and one end of the conductive tape is stuck on the dielectric film via the conductive sticky layer and the other end of the conductive tape is electrically grounded.

Preferably, the conductive sticky layer has a sheet resistivity in a range of 10 Ω/cm² to 1 KΩ/cm², and contains carbon.

Preferably, the dielectric film has a thickness in a range of 10 nm to 250 nm.

Preferably, the conductive film has a sheet resistance in a range of 100 Ω/□ to 1 KΩ/□.

Preferably, the other end of the conductive tape is connected to a ground portion via the conductive sticky layer.

According to the display apparatus having the above configuration, the conductive tape is stuck on the dielectric film (which is represented by a anti-reflection film) via the conductive sticky layer, and the dielectric film is provided to cover the surface of the conductive film; however, since the dielectric film is as very thin as 10 nm to 250 nm, the conductive film can be electrically connected to the ground portion of the display apparatus via the conductive tape. As a result, it is possible to suppress the occurrence of electrostatic charges on the display screen and leakage of an electromagnetic field from the display screen to the outside of the display apparatus.

Further, since the conductive sticky layer of the conductive tape has a specific electrical resistance, even if the amount of electrostatic charges on the display screen is rapidly changed due to a discharge or the like generated in the display apparatus, a differential potential between the conductive film and the conductive tape can be moderated, to suppress a discharge between the conductive film on the display screen and the conductive tape, thereby preventing the occurrence of sputtering therebetween. This makes it possible to prevent the conductive film from being broken due to the above sputtering.

### BRIEF DESCRIPTION OF THE DRAWINGS

FIG. 1 is a side view of a configuration example of a cathode ray tube representative of a display apparatus of the present invention, illustrating a state in which a front surface of the cathode ray tube is connected to a band portion of the cathode ray tube with a conductive tape;

FIG. 2 is a sectional view of an essential portion of the cathode ray tube shown in FIG. 1, illustrating a connection portion at which the front surface of the cathode ray tube is connected to the band portion of the cathode ray tube by the conductive tape;

FIG. 3 is a sectional view of a film used for the present invention, illustrating an arrangement of a plastic base, a conductive film, and a anti-reflection film of the film;

FIG. 4 is a sectional view of the conductive tape according to an embodiment of the present invention, illustrating an arrangement of a tape base and a conductive sticky layer of the conductive tape; and

FIG. 5 is a diagram of an equivalent circuit of a path through which a current flows from the front surface of the cathode ray tube to the band portion of the cathode ray tube, illustrating the effect of the present invention.

### DETAILED DESCRIPTION OF PREFERRED EMBODIMENT

Hereinafter, a preferred embodiment of the present invention will be described in detail with reference to the accompanying drawings.

FIG. 1 is a schematic view showing a display apparatus of the present invention.

Referring to FIG. 1, there is shown a cathode ray tube (hereinafter, referred to as “CRT”) 1 representative of the display apparatus of the present invention. The CRT 1 has a panel portion 2, a funnel portion 3, and a neck portion 4.

Phosphors of red, green, and blue for display these three primary colors are arranged in a specific pattern on the inner surface of the panel portion 2. An outer conductive film 5 made from carbon or the like is formed on the outer surface of the funnel portion 3. An electron gun (not shown) as a source for emission of electron beams is mounted in the neck portion 4. Deflection yokes (not shown) for deflecting electron beams in the vertical and horizontal directions are mounted to a cone portion extending from the funnel portion 3 to the neck portion 4.

A band 6 made from a metal for preventing the implosion of the CRT 1 is wound around the outer periphery of the panel portion 2. The band 6 is connected to a circuit (not shown) of the CRT 1, and is electrically grounded, together with the outer conductive film 5.

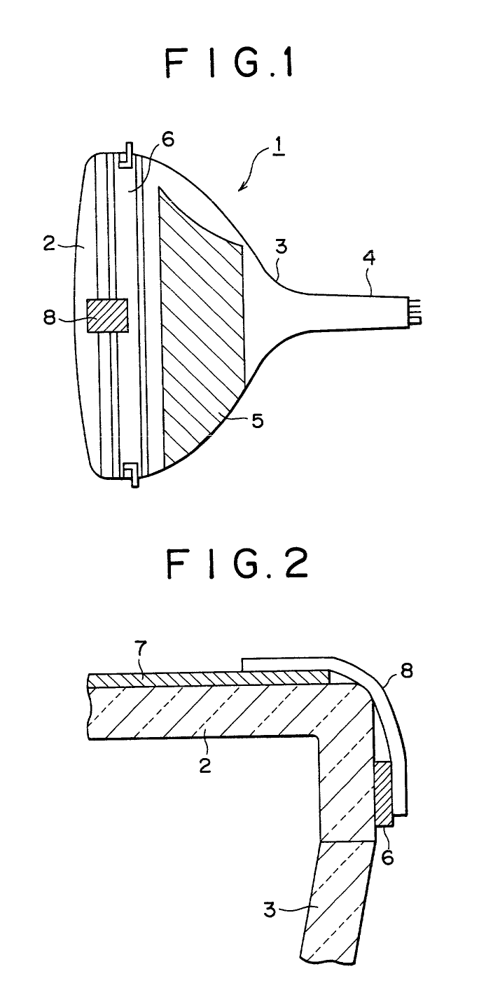

Referring to FIG. 2, a stacked film 7 is stuck overall on a front surface, that is, a display screen of the panel portion 2. A conductive tape 8 is provided on an outer peripheral portion of the panel portion 2 in such a manner that one end side thereof is stuck on an outer peripheral portion of the stacked film 7 and the other end side thereof is stuck on the band 6. In addition, although only one conductive tape 8 is shown in FIG. 1, a plurality of the conductive tapes 8 may be provided on the panel portion 2.

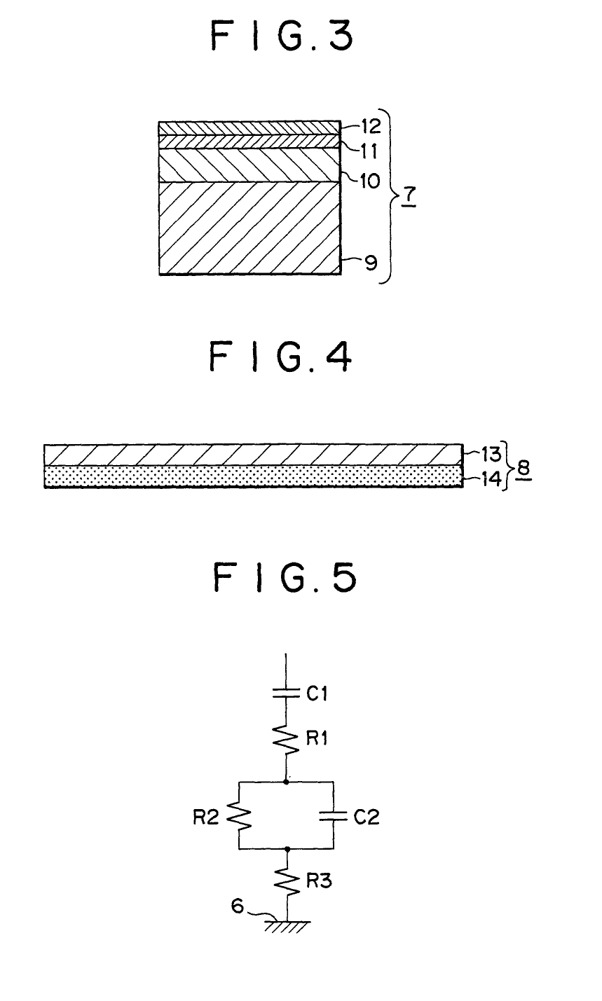

FIG. 3 shows one configuration example of the stacked film 7. The stacked film 7 is composed of a plastic base 9, a hard coat layer 10, a transparent conductive film 11, and a anti-reflection film 12.

The plastic base 9, which is the base member for the stacked film 7, is made from polyethylene terephthalate, polycarbonate, or polymethyl methacrylate. The thickness of the plastic base 9 can be suitably selected but may be generally in a range of 50 to 250 μm from the viewpoint of easy handling or the like.

The hard coat layer 10 is provided for reinforcing the wear resistance of the plastic base 9, thereby protecting the surface of the plastic base from being damaged. The hard coat layer 10 is made from acrylic resin, silicon resin, melamine resin, or epoxy resin.

The conductive film 11 has a function of preventing electostatic charge on the panel portion 2, and a function of preventing the leakage of an electromagnetic field to the front surface of the penal portion 2. The conductive film 11 is provided on the hard coat layer 10 by forming a film of an oxide such as ITO or SiO₂ or a metal such as Pd, Au, Cr, or Ti to a thickness of 1 to 500 nm by, for example, a sputtering process.

The anti-reflection film 12 is provided for preventing the reflection of light from the front surface of the panel portion 2, thereby enhancing the visibility of a display image. The anti-reflection film 12 is provided on the conductive film 11 by forming a dielectric substance such as SiO₂ , Al₂O₃, ZrO₂, or TiO₂ to a thickness of 10 to 200 nm by, for example, a PVD (Physical Vapor Deposition) process such as a vacuum vapor deposition process, an ion plating process, or a sputtering process. It is to be noted that the anti-reflection film 12 may be of a multi-layer structure of a stack of two layers or three or more layers.

FIG. 4 is a sectional view showing a configuration example of the conductive tape.

Referring to FIG. 4, the conductive tape 8 is composed of a conductive tape base 13 and a conductive sticky layer 14. The one end side and the other end side of the conductive tape 8 are stuck on the stacked film 7 and the band 6 via the conductive sticky layer 14, respectively.

The tape base 13 is made from a conductive material such as a metal. Preferably, the tape base 13 is made from a metal such as copper or aluminum, which exhibits a suitable bending workability when being formed into a thin shape. Additionally, the tape base 13 may be formed by coating the surface of a plastic tape with a conductive metal by, for example, a vacuum vapor deposition process, a sputtering process, or a plating process.

The conductive sticky layer 14 is, as described above, electrically connected to the conductive film 11 via the anti-reflection film 12 formed into a thin-film shape. The conductive sticky layer 14 is formed by preparing a paste by mixing a fine conductive agent in the form of particles, fibers, or powders in a sticky agent such as acrylic resin, epoxy resin, or polyimide resin, and coating one surface of the tape base 13 with the paste. The conductive sticky layer 14 has a specific electrical resistance. Concretely, a sheet resistivity (electrical resistance/cm²) of the conductive sticky layer 14 in the thickness direction is in a range of 10Ω to 1 KΩ/cm², preferably, 10Ω to 500Ω/cm², more preferably, 10Ω to 200 Ω/cm².

In general, a metal may be regarded as a conductive agent mixed to a sticky agent. In this embodiment, however, the use of a metal having a very low electrical resistance as the conductive agent makes difficult to give a specific sheet resistivity to the conductive sticky layer 14.

In this embodiment, carbon is preferably used as the conductive agent because it can easily adjust the sheet resistivity of the conductive sticky layer 14.

In the display apparatus having the above-described display apparatus, one end of the conductive tape 8 is connected to the conductive film 11 of the stacked film 7 via the anti-reflection film 12 of the stacked film 7 and the conductive sticky layer 14 of the conductive tape 8; and the other end of the conductive tape 8 is connected to the band 6 via the conductive sticky layer 14 of the conductive tape 8.

In this case, the anti-reflection film 12 is made from a dielectric substance such as SiO₂, which is an insulating material. However, if the thickness of the anti-reflection film 12 is very thin, a current flows between the conductive film 11 and the conductive tape 8. Accordingly, the conductive film 11 is electrically connected to the band 6 via the conductive tape 8.

In particular, since the thickness of the anti-reflection film 12 is as very thin as for example 250 nm or less for ensuring the anti-reflection function thereof, even if the anti-reflection film 12 is interposed between the conductive film 11 and the conductive tape 8, a current flows between the conductive film 11 and the conductive tape 8.

As a result of experiment made by the present inventors, it was confirmed that, assuming that the thickness of the anti-reflection film 12 is set to 100 nm, a current of about 15 mA/cm² flows at a voltage of 0.2 V in accordance with a formula of space-charge limited current. Further, when the conductive film 11 was made to face to the conductive sticky layer 14 via the anti-reflection film 12 formed of a dielectric substance having a thickness of 100 nm, 50 nF per 10 cm² was observed.

In the CRT 1 configured as described above, the conductive film 11 can be grounded together with the band 6 by electrically connecting the conductive film 11 to the band 6 via the conductive tape 8. As a result, it is possible to prevent the occurrence of electrostatic charges on the surface of the panel portion 2, and to effectively prevent leakage of an electromagnetic field generated in the CRT by suitably selecting the sheet resistance of the conductive film in a range of 100Ω/□ to 10 KΩ/□.

Further, by giving a suitable electrical resistance to the conductive sticky layer 14 of the conductive tape 8, it is possible to prevent the occurrence of sputtering between the conductive tape 8 and the conductive film 11 even if the amount of electric charges on the surface of the panel portion 2 is rapidly changed, and hence to prevent the conductive film 11 from being broken due to the sputtering.

The present invention will be more clearly understood by way of the following examples:

### INVENTIVE EXAMPLE 1

Preparation of Stacked film 7

A stacked film 7 was prepared in accordance with the following procedure. A plastic base 9 formed of a polyethylene terephthalate sheet having a thickness of 188 μm was coated with an ultraviolet curing type acrylic resin to a thickness of about 10 μm, followed by ultraviolet curing of the coating resin, to form a hard coat layer 10 on the plastic base 9. A conductive film 11 was formed on the hard coat layer 10 by depositing ITO (Indium Tin Oxide) on the hard coat layer 10 to a thickness of 130 nm by a sputtering process, and a anti-reflection film 12 was formed on the conductive film 11 by depositing SiO₂ on the conductive film 11 to a thickness of 100 nm by the sputtering process.

Sticking of Stacked film 7

The stacked film 7 thus prepared was stuck on a front surface of a panel portion 2 of a CRT 1 as shown in FIG. 1. The sticking of the stacked film 7 was performed by coating a back surface, opposed to a surface covered with the hard coat layer 10, of the plastic base 9 with an acrylic resin based adhesive, followed by drying of the adhesive, and the back surface of the plastic base 9 coated with the adhesive was overall brought into press-contact with the front surface of the panel portion 2.

Preparation of Conductive Tape 8

A conductive tape 8 was prepared by forming a conductive sticky layer 14 on one surface of a tape base 13 made from copper. To be more specific, a material obtained by mixing carbon particles representative of a conductive agent in an acrylic resin based sticky agent was stacked on the tape base 13, to form the conductive sticky layer 14 on the tape base 13. The sheet resistivity of the conductive sticky layer 14 was 30 Ω/cm².

Sticking of Conductive Tape 8

One end portion and the other end portion of the conductive tape 8 thus prepared were stuck on the stacked film 7 and the band 6 at positions on the outer periphery of the panel portion 2, respectively. The contact area between the stacked film 7 and the conductive tape 8 was set to 15 cm².

Here, if a film made from a fluorine compound or the like is formed on the anti-reflection film 12 of the stacked film 7, the fluorine compound or the like may be removed, before sticking of the conductive tape 8, by subjecting the surface of the stacked film 7 to a high frequency corona treatment performed at a discharge amount of 35 to 250 W/m²/min, preferably, 70 to 150 W/m²/min. As a result, the wettability of the surface of the stacked film 7 can be improved. This makes it possible to enhance the adhesiveness between the stacked film 7 and the conductive tape 8, and hence to stabilize the quality.

### COMPARATIVE EXAMPLE

The same procedure as that in Inventive Example was repeated, except that the sheet resistivity of the conductive sticky layer 14 of the conductive tape 8 was set to 0.3Ω/cm², to prepare a comparative CRT.

Experiment for Evaluating Durability

The durability of each of the CRTs prepared in Inventive Example and Comparative Example was evaluated by forcibly-causing discharges in the CRT so as to repeatedly generate high electric charges on the surface of the panel portion, and measuring a resistance between the conductive film and the band (including the sheet resistance of the conductive film) at each of specific numbers (0, 100, 200, 500, and 1000 times) of discharge.

The evaluated results are shown in Table 1.

TABLE 1
Number of

| discharge | 0 | 100 | 200 | 500 | 1000 |
|---|---|---|---|---|---|
| Inventive | 362 Ω | 291 Ω | 278 Ω | 378 Ω | 255 Ω |
| Example | | | | | |
| Comparative | 307 Ω | 2 M Ω | [symbol] | — | — |
| Example | | | | | |

As is apparent from Table 1, for the CRT prepared in Inventive Example, the resistance was little changed and the conductive film was not broken even after the discharge was repeated by 1000 times. On the contrary, for the CRT prepared in Comparative Example, the resistance was significantly increased after the discharge was repeated by 100 times, and the resistance became infinite and the conductive film was broken after the discharge was repeated by 200 times.

Here, the reason why the CRT prepared in Inventive Example was desirably evaluated will be described with reference to an equivalent circuit shown in FIG. 5. In this figure, a capacitance between the inner surface of the panel portion and the conductive film of the stacked film is designated by C1; a capacitance between the conductive tape and the conductive film is designated by C2; a sheet resistance of the conductive film is designated by R1; a resistance of the anti-reflection film (dielectric substance) is designated by R2; and a resistance of the conductive sticky layer is designated by R3.

When a discharge is generated in the CRT prepared in Inventive Example, as shown by the equivalent circuit of FIG. 5, a potential generated from the inner surface of the CRT is divided by C1 and C2 and further divided by R1 and R2. Accordingly, a potential applied between both ends of R2 and C2 is suppressed, to thereby avoid the occurrence of sputtering between the conductive film and the conductive tape. As a result, even if discharges are repeatedly generated in the CRT, the conductive film is never broken.

However, if the value of R3 becomes excessively large, a potential between the conductive film and the band becomes higher, with a result that a discharge may be caused therebetween. Accordingly, in consideration of this regard, the value of R3 should be selected. In addition, as a result of experiments made by the present inventors, a discharge was observed between the conductive film and the band under a condition of R3=10 KΩ.

Further, in the CRT prepared in Inventive Example as compared with a CRT with no conductive film 11, it was confirmed that an electromagnetic field in a VLF band was reduced from 2.37 V/m to 0.75 V/m, and an electromagnetic field in an ELF band was reduced from 25.4 V/m to 5.25 V/m.

By the way, in the above-described embodiment, the conductive tape 8 is prepared by forming the conductive sticky layer 14 overall on one surface of the tape base 13; however, the conductive tape 8 may be prepared by forming the conductive sticky layer 14 only on portions, to be bonded to the stacked film 7 and the band 6, of the tape base 13.

In the above-described embodiment, the conductive tape 8 is electrically connected to the band 6 via the conductive sticky layer 14; however, to enhance the electrical connection between the conductive tape 8 to the band 6, the conductive tape 6 may be further forcibly connected to the band 6 by soldering or the like.

In the above-described embodiment, the band 6 is used as a ground portion of the CRT; however, the present invention is not limited thereto. For example, the outer conductive film 5 formed on the outer surface of the funnel portion 3 may be used in place of the band 6.

Further, in the above-described embodiment, the present invention is applied to a CRT; however, the present invention is not limited thereto but may be applicable to another display apparatus such as a plasma display.

While the preferred embodiment of the present invention has been described using the specific terms, such description is for illustrative purposes only, and it is to be understood that changes and variations may be made without departing from the spirit or scope of the following claims.

What is claimed is:

1. A display apparatus having a display screen, comprising:
a conductive film stuck on said display screen;
a dielectric film formed on the surface of said conductive film; and
a conductive tape including a conductive base and a conductive sticky layer;
wherein said conductive sticky layer has a specific electrical resistance; and
one end of said conductive tape is stuck on said dielectric film via said conductive sticky layer and the other end of said conductive tape is electrically grounded.

2. A display apparatus according to claim 1, wherein said conductive sticky layer has a sheet resistivity in a range of 10Ω/cm² to 1 KΩ/cm².

3. A display apparatus according to claim 1, wherein said conductive sticky layer contains carbon.

4. A display apparatus according to claim 1, wherein said dielectric film has a thickness in a range of 10 nm to 250 nm.

5. A display apparatus according to claim 1, wherein said conductive film has a sheet resistance in a range of 100Ω/□ to 1 KΩ/□.

6. A display apparatus according to claim 1, wherein the other end of said conductive tape is connected to a ground portion via said conductive sticky layer.
